(19) United States
(12) Patent Application Publication
(10) Pub. No.: US 2017/0302879 A1
(43) Pub. Date: Oct. 19, 2017

(54) COMMUNICATION APPARATUS, CONTROL METHOD THEREOF, INFORMATION PROCESSING APPARATUS, AND RECORDING MEDIUM

(71) Applicant: CANON KABUSHIKI KAISHA, Tokyo (JP)

(72) Inventors: Koshi Tokunaga, Kawasaki-shi (JP); Tomoya Asanuma, Kawasaki-shi (JP); Tomoki Kuroda, Tokyo (JP); Ryoji Yoshie, Tokyo (JP)

(21) Appl. No.: 15/483,847

(22) Filed: Apr. 10, 2017

(30) Foreign Application Priority Data
Apr. 14, 2016 (JP) 2016-081375
Jul. 12, 2016 (JP) 2016-137688

(51) Int. Cl. H04N 5/77; H04L 29/08; H04N 5/44; H04N 5/38; H04L 29/06

(52) U.S. Cl. CPC H04N 5/77; H04N 5/44; H04N 5/38; H04L 67/02; H04L 67/06; H04L 67/42

(57) ABSTRACT

A communication apparatus specifies content to be transmitted to an external apparatus, out of pieces of content recorded in a recording medium, and when there is a plurality of specified pieces of content, transmits first content out of the plurality of pieces of content to the external apparatus, and after the transmission of the first content, receives a notification of receipt of the first content from the external apparatus, and when the notification is received, deletes the first content from the recording medium, and after the deletion of the first content, transmits second content out of the plurality of pieces of content to the external apparatus.

### BACKGROUND

### Field of the Disclosure

The present disclosure generally relates to communications and, more particularly, to a communication apparatus communicating with an external apparatus, a control method thereof, an information processing apparatus, and a recording medium.

### Description of the Related Art

There are known digital cameras and digital video cameras with wireless communication function (for example, refer to Japanese Patent Laid-Open No. 2008-097213). These digital cameras and digital video cameras can connect to networks using the wireless communication function and upload captured image data to external apparatuses on the networks.

The foregoing technique is assumed to be not only used by general users of digital cameras but also is to be applied for various kinds of business use. In some of use cases including the business use, captured images need to be rigidly managed.

In medical settings, for example, the affected areas of patients are photographed by a digital camera and the captured images are managed in association with patients' identifications (IDs). In this case, the images of the affected areas are personal information and are desirably disposed of at once when they become unnecessary any more.

### SUMMARY

According to one or more aspects of the present disclosure, a communication apparatus includes: a specifying unit that specifies content to be transmitted to an external apparatus, out of pieces of content recorded in a recording medium; a transmission unit that, when the specifying unit specifies a plurality of pieces of content, transmits first content out of the plurality of pieces of content to the external apparatus; a reception unit that, after the transmission unit transmits the first content, receives a notification of receipt of the first content from the external apparatus; and a deletion unit that, when the reception unit receives the notification of receipt of the first content from the external apparatus, deletes the first content from the recording medium, wherein, after the deletion unit deletes the first content, the transmission unit transmits second content out of the plurality of pieces of content to the external apparatus.

Further features of the present disclosure will become apparent from the following description of exemplary embodiments (with reference to the attached drawings).

### BRIEF DESCRIPTION OF THE DRAWINGS

FIG. 1 is a block diagram of a functional configuration example of a digital camera as an example of a communication apparatus according to one or more aspects of the present disclosure.

FIG. 2 is a block diagram of a function configuration example of a personal computer that can implement an information processing apparatus according to one or more aspects of the present disclosure.

FIG. 3 is a schematic diagram illustrating a connection mode of a digital camera and a personal computer (PC) according to one or more aspects of the present disclosure.

FIG. 4 is an operational sequence diagram of the digital camera, the PC, and a server according to one or more aspects of the present disclosure.

FIGS. 5A to 5D are diagrams illustrating graphical user interfaces (GUIs) of the digital camera according to one or more aspects of the present disclosure.

FIG. 6 is a flowchart of operations of the digital camera according to one or more aspects of the present disclosure.

FIG. 7 is an operational sequence diagram of the digital camera, a PC, and a server according to one or more aspects of the present disclosure.

FIG. 8 is a flowchart of operations of the digital camera according to one or more aspects of the present disclosure.

FIG. 9 is a schematic diagram illustrating a connection mode of a digital camera, a digital photo storage, and an image management server according to one or more aspects of the present disclosure.

FIG. 10 is an operational sequence diagram of the digital camera, the digital photo storage, and the image management server according to one or more aspects of the present disclosure.

FIG. 11 is a flowchart of operations of the digital photo storage according to one or more aspects of the present disclosure.

FIG. 12 is an operational sequence diagram of a user, a digital photo storage, and an image management server according to one or more aspects of the present disclosure.

FIG. 13 is a flowchart of operations of the digital photo storage according to one or more aspects of the present disclosure.

### DESCRIPTION OF THE EMBODIMENTS

Illustrative embodiments of one or more aspects of the present disclosure will be described below in detail with reference to the accompanying drawings.

### First Embodiment

### <Configuration of a Digital Camera>

A digital camera having wireless communication function as an example of a communication apparatus that is a data transmission source will be described below. The present disclosure is applicable to arbitrary apparatuses having wireless communication function and being capable of data transmission. These terminals include cellular phones, personal computers, tablet terminals, game machines, and others, for example, but may be any other devices. These devices desirably include an imaging unit but may not necessarily include it as far as they have the function of capturing image data from digital cameras or the like, for example.

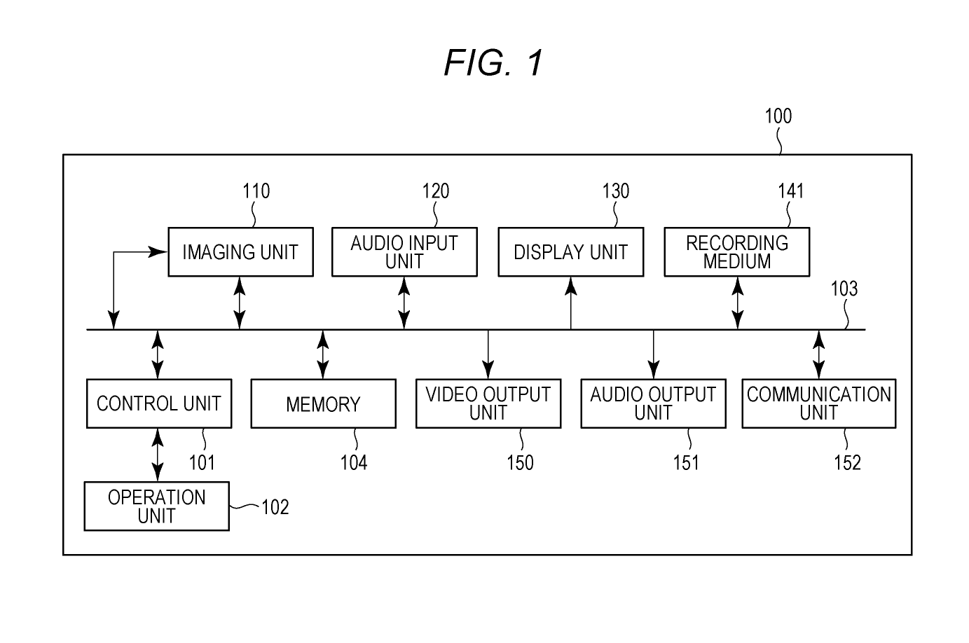

FIG. 1 is a block diagram of a functional configuration example of a digital camera 100 according to the embodiment. A control unit 101 may be composed of one or more processors and memories, e.g. a central processing unit (CPU), a micro processing unit (MPU), memories (Digital Random Access Memory (DRAM), Static Random Access Memory (SRAM), etc.), and the like, for example, and executes various processes (programs) to control the blocks of the digital camera 100 and control data transmission between the blocks. The control unit 101 also controls the blocks of the digital camera 100 according to operation signals from an operation unit 102 that accepts operations from a user. As used herein, the term “unit” generally refers to hardware, firmware, software or other component, such as circuitry, alone or in combination thereof, that is used to effectuate a purpose.

The operation unit 102 includes, for example, switches for inputting various operations related to photographing such as a power button, a zoom adjustment button, and an auto focus button. The operation unit 102 may also include a menu display button, a determination button, a cursor key, a pointing device, a touch panel, and others. When the user operates these keys and buttons, the operation unit 102 transmits operation signals to the control unit 101. The operation unit 102 further includes a release button that has a switch (SW1) to be depressed in a half-stroke state and a switch (SW2) to be depressed in full-stroke state. An instruction for preparing for photographing is output by a depression of the SW1, and an instruction for image shooting is output by a depression of the SW2. The photographing preparation operations include auto focus detection (AF), auto exposure control (AE), and the like. In the embodiment, the one release button acts as a release button for shooting still images and a release button for shooting moving images, but separate buttons may be provided. In the example, the operation unit 102 includes the foregoing operation members and a button for starting communication with another apparatus via a communication unit 152 when being operated.

A bus 103 is a general-purpose bus for sending various kinds of data, control signals, instruction signals, and others to the blocks of the digital camera 100.

An imaging unit 110 controls by a diaphragm the light amount of an optical image of a subject taken in by an imaging lens, and converts the image into an image signal by an imaging element such as a CCD image sensor or a CMOS image sensor.

An audio input unit 120 collects sounds around the digital camera 100 by a built-in non-directional microphone or an external microphone connected via an audio input terminal, for example.

A memory 104 is random access memory (RAM) or rewritable non-volatile memory, for example, to store temporarily image signals, audio signals, setting information on the digital camera 100, and others.

A recording medium 141 is a recording medium connectable to the digital camera 100. The recording medium 141 can record various kinds of data created by the digital camera 100. Examples of the recording medium 141 include a hard disk, an optical disk, a rewritable non-volatile semiconductor memory, and others. In the embodiment, a rewritable non-volatile semiconductor memory device that is called a memory card and attachable to the digital camera 100 is used as the recording medium 141.

A video output unit 150 is composed of a video output terminal, for example, to transmit image signals to display video on a connected external display or the like. The video output unit 150 and an audio output unit 151 described later may be provided as one integrated terminal, for example, such as a High Definition Multimedia Interface (HDMI (registered trademark)) terminal, for example.

The audio output unit 151 is composed of an audio output terminal, for example, to transmit audio signals to output sounds from a connected earphone or speaker. The audio output unit 151 may be built in the digital camera 100.

The communication unit 152 performs data transmission and reception by serial or parallel communications with external devices in a wired or wireless manner. Examples of communication interfaces usable by the communication unit 152 are RS232C, USB, IEEE1394, P1284, SCSI, modem, LAN, IEEE802.11x, and the like. The communication unit 152 can also perform data transmission and reception with external devices by executing communication protocols according to the communication interfaces. Examples of communication protocols include Hyper Text Transfer Protocol (HTTP) and Picture Transfer Protocol over IP (PTP-IP). The communication interfaces and the communication protocols listed here are well known and detailed descriptions thereof are omitted here. The recording medium 141 may include the function of the communication unit 152.

A display unit 130 displays image data recorded in the recording medium 141 and GUIs such as various menus. The display unit 130 may be a liquid crystal display, an organic EL display, or the like, for example.

In the embodiment, the control unit 101 controls the entire digital camera 100. However, the control method is not limited to this. For example, a plurality of hardware devices may control the components of the digital camera 100 by sharing the processes or performing the same in cooperation.

### <Configuration of a Personal Computer (PC)>

In the following description, as an example of an information processing apparatus capable of implementing a user terminal and a server according to the embodiment of the present disclosure, a personal computer (PC) capable of capturing still images and moving images will be discussed. Examples of the information processing apparatus include a tablet-type PC and a smartphone.

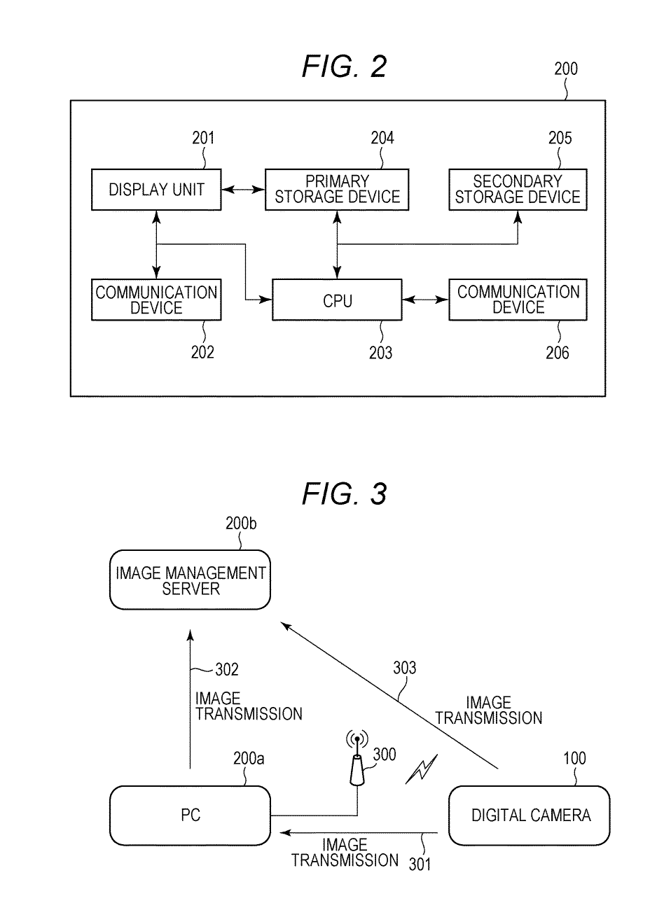

FIG. 2 is a block diagram of a function configuration example of a PC 200 according to one or more aspects of the present disclosure.

The PC 200 has a display unit 201, an operation unit 202, a CPU 203, a primary storage device 204, a secondary storage device 205, and a communication device 206.

Basic functions of the components are the same as those of the digital camera 100 and detailed descriptions thereof are omitted here. The display unit 201 may be a liquid crystal display, an organic EL display, or the like. The PC 200 may not necessarily include the display unit 201 as far as the PC 200 has the display control function of controlling display on the display unit 201. The primary storage device 204 may be RAM or rewritable non-volatile memory that holds setting values of the PC, holds and unfolds programs to be executed by the CPU 203, or is used as a working area for the CPU 203. The secondary storage device 205 is a magnetic recording device such as an HDD or a magnetic tape drive, a storage device using optical media or magneto-optical media such as DVD, CD, BD, and MO, or a recording device using a non-volatile semiconductor memory such as SSD. The secondary storage device 205 is used to save various applications (including an OS) and user data.

The CPU 203 executes programs (OS, applications, and others) unfolded in the primary storage device 204 to control the blocks of the PC 200. The CPU 203 also controls the blocks according to operation signals from the operation unit 202 that accepts operations from the user. The operation unit 202 may be generally a keyboard, a mouse, or a touch panel but is not limited to them.

The communication device 206 communicates with external devices using communication interfaces and communication protocols under predetermined standards as the communication unit 152 of the digital camera 100 does. The communication unit 152 and the communication device 206 have a plurality of kinds of communication interfaces and can perform communications under communication protocols according to the communication interfaces. In one or more aspects of the present disclosure, the communication device 206 is configured to be communicable with both devices on a local area network (LAN) and devices on a wide area network (WAN) such as the Internet. The LAN and the WAN are examples of two different networks, and the communication device 206 can connect to both a first network accessible from a data source device and a second network on which there exists a server providing data transmission service.

A video output unit 208 is composed of a video output terminal, for example, that transmits image signals to display video on a connected external display or the like. Alternatively, the video output unit 208 may be one terminal into which a video output terminal and an audio output terminal are integrated, for example, such as an HDMI (registered trademark) terminal.

In one or more aspects of the present disclosure, the CPU 203 controls the entire PC 200. However, the control method is not limited to this. For example, a plurality of hardware devices may control the components of the PC 200 by sharing the processes or performing the same in cooperation.

Both the server and the user terminal according to one or more aspects of the present disclosure can be implemented by the personal computer illustrated in FIG. 2. For convenience sake, however, the term “PC” will be used to mean the user terminal, and the PC acting as the server will be called “server” in the following description.

### <Overview of a Connection Mode>

FIG. 3 is a schematic diagram illustrating a connection mode of the digital camera 100, a PC 200a, and a server 200b according to one or more aspects of the present disclosure.

The digital camera 100 and the PC 200a can connect to a local area network (LAN) built by a router 300 in wireless and wired manners and connect to a wide area network (WAN) such as the Internet through the router 300 to communicate with the server 200b on the WAN.

The router 300 provides the network building function and the routing function to relay communications between devices such as portable devices and PCs connected to the built network. The router 300 acts in conformity with the Internet protocol suite to build a LAN with its own IP address as a Gateway address. The router 300 has at least one of a wired interface and a wireless interface. An example of wired connection is physical connection of the router and the device via a LAN cable, and an example of wireless connection is wireless connection in conformity with IEEE802.11x (x represents a, b, g, n, ac, or the like). The router 300 according to one or more aspects of the present disclosure has a wired interface and a wireless interface as illustrated in the drawing.

When the router 300 has a wireless interface, the router 300 is set with a service set identifier (SSID) and an encryption key. The connection devices are authenticated by the router 300 with the SSID and the encryption key set to the router 300 and then connected wirelessly to the router 300. When the devices such as portable devices and PCs are connected to its own LAN in a wired or wireless manner, the router 300 assigns IP addresses to the connected devices. For example, a typical protocol for automatic assignment of IP addresses is Dynamic Host Configuration Protocol (DHCP). The router 300 also analyzes the protocols of data flowing over the LAN and the IP addresses when devices on the LAN communicate with each other to determine through which path the data is to be transmitted.

A secondary storage device 105 of the digital camera 100 according to one or more aspects of the present disclosure has a program installed to allow communications with the PC 200a under discovery protocols for making a device search on the network. In this example, the discovery protocols are protocols allowing communications in conformity with specifications of Universal Plug and Play (UPnP) and Bonjour, but the discovery protocols are not limited to them. Therefore, the digital camera 100 records commands for executing communications with the use of UPnP and Bonjour and device information specific to the digital camera 100 necessary for communications with the use of UPnP and Bonjour.

The secondary storage device 205 of the PC 200a according to one or more aspects of the present disclosure also has a program installed to allow communications with the digital camera 100 in conformity with the specifications of UPnP and Bonjour. Therefore, the PC 200a records commands for executing communications with the use of UPnP and Bonjour and device information specific to the PC necessary for communications with the use of UPnP and Bonjour.

The digital camera 100 and the PC 200a discover each other by device discovery using the discovery protocols described above.

The discovery protocols for use according to one or more aspects of the present disclosure, UPnP and Bonjour, will be described. UPnP is a technical specification to allow devices such as domestic PCs and peripherals, AV devices, telephones, home electric appliances to connect with one another via a network and provide their functions to one another. Bonjour is a technique for automatically detecting and connecting devices on an IP network such as a wireless LAN like Ethernet (registered trademark) or 802.11 series. Under Bonjour, communications not involving with the router are determined as local networking and IP addresses are automatically acquired. In addition, names are given using multicast DNS that does not necessarily need to set a local host name. Further, service search is carried out by finding a device with desired function. These protocol specifications are publicly available and detailed descriptions thereof are omitted.

The present disclosure is not limited to the specific discovery protocols described herein but may be carried out in communications using other protocols. For example, Jini provided by Sun Microsystems Inc. may be used as another discovery protocol.

The foregoing device discovery allows the establishment of communications between the digital camera 100 and the PC 200a to transmit image files form the digital camera 100 to the PC 200a.

The secondary storage device 105 of the digital camera 100 according to one or more aspects of the present disclosure has a program installed to allow communications with the PC 200 in conformity with HTTP as a protocol for image transmission. This program has both the function of transmitting as an HTTP client a request to an HTTP server and the function of receiving as an HTTP server a request from an HTTP client and performing a process according to the request. In addition, the secondary storage device 205 of the PC 200a according to one or more aspects of the present disclosure has a program installed to allow communications with the digital camera 100 in conformity with HTTP. This program has the function of transmitting as an HTTP client a request to an HTTP server.

The present disclosure is not limited to the specific image transfer protocol described here but can be carried out in communications using other protocols. For example, the image files may be transmitted to the PC 200a using PTP-IP. PTP-IP is an abbreviation of Picture Transfer Protocol over TCP/IP networks.

According to one or more aspects of the present disclosure, image files are recorded in advance in the recording medium 141 of the digital camera 100 and the secondary storage device 205 of the PC 200a. In the embodiment, the image files are transmitted in such a manner that the digital camera 100 and the PC 200a are connected together over a network, and the image files supplied from the digital camera 100 are saved in an arbitrary directory of the secondary storage device 205 of the PC 200a.

The images are transmitted through paths 301, 302, and 303.

In the communication 301, the image files in the recording medium 141 of the digital camera 100 are transmitted to the PC 200a. When the user provides from the operation unit 102 an instruction for transmitting the image files to the PC 200a, the control unit 101 of the digital camera 100 executing the foregoing program connects to the local area network built by the router 300 via the communication unit 152. Next, the digital camera 100 searches the local area network to verify whether the PC 200a exists. As the result of the search, the digital camera 100 and the PC 200a discover each other, the digital camera 100 executes the function of the HTTP server to prepare for providing the image files to the outside, and waits for an acquisition request from the HTTP client. The PC 200a executes the function of the HTTP client to transmit a request for acquiring the image files to the digital camera 100 and acquire the image files directly from the digital camera 100 through the communication 303.

In the communication 302, the image files in the secondary storage device 205 of the PC 200a are periodically transmitted to the server 200b managing image files.

This system is applicable to medical settings, for example, in such possible application examples as described below. There is a terminal prepared for temporarily saving image files such as the PC 200a in hospital facilities. The doctors and nurses shot images of affected areas of patients. The images in the digital camera 100 are temporarily saved in the PC 200a in an automatic manner or by the doctor's or nurse's operation. The server 200b regularly monitors the saved state of the image files in the PC 200a and acquires an image file to be managed when detecting it.

In the environment with only the image management server 200b, the image files may be transmitted directly from the digital camera 100 to the image management server 200b via the router 300.

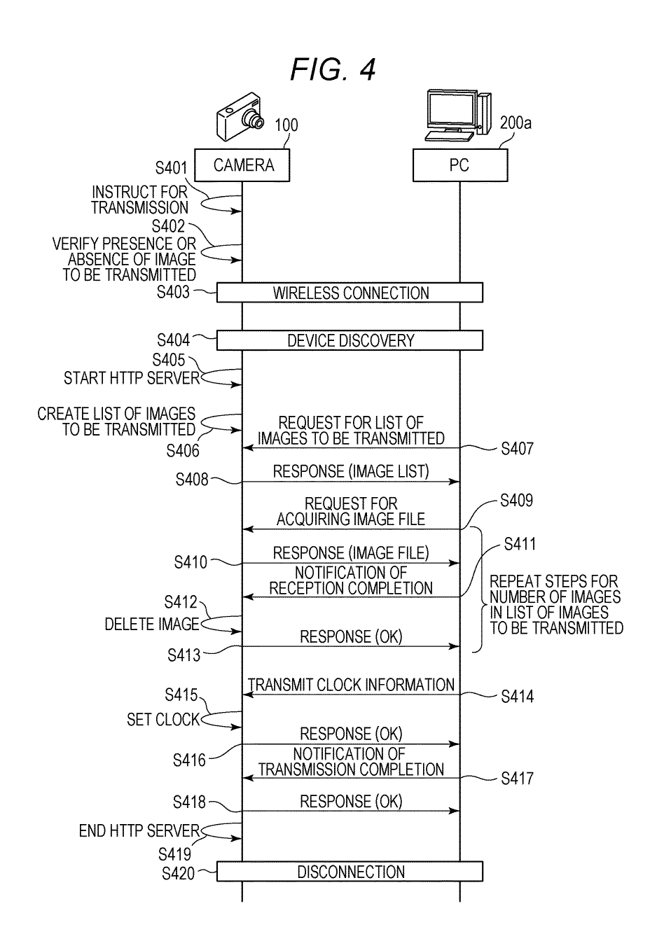

According to one or more aspects of the present disclosure, the digital camera 100 and the PC 200a transmit and receive data in conformity with HTTP. The HTTP server refers to a software application or a computer that has the information transmission function in the World Wide Web (WWW) system. The HTTP server holds pieces of content and transmits content files to an HTTP client in response to requests by HTTP methods such as Get, Post, and Head from the HTTP client. The HTTP client refers to a software application or a computer that transmits a request to the HTTP server by using the HTTP methods. According to one or more aspects of the present disclosure, the request for acquiring an image is a command based on the HTTP method and the pieces of content refer to image data. The details of image transmission between the digital camera 100 and the PC 200a at the time of transmission of image files in the communication 303 will be described later with reference to FIGS. 4 to 8. The overview of the image file transmission procedure according to one or more aspects of the present disclosure has been described so far. As a matter of course, the request for acquiring an image may be implemented under another communication protocol or the pieces of content may be audio or document files.

### <Image Transmission Sequence>

Next, detailed descriptions will be given as to a sequence of transmitting the image files saved in the recording medium 141 of the digital camera 100 to the PC 200a in the communication 301. The operations of the digital camera 100 in the following sequence and flowchart are implemented by the control unit 101 controlling the components of the digital camera 100 according to the program. The operations of the PC 200a are implemented by the CPU 203 controlling the components of the PC 200a according to the program.

FIG. 4 is an operational sequence diagram of the digital camera 100 and the PC 200a according to one or more aspects of the present disclosure. This sequence is started when the user of the digital camera 100 has shot images and a plurality of image files is saved in the recording medium 141.

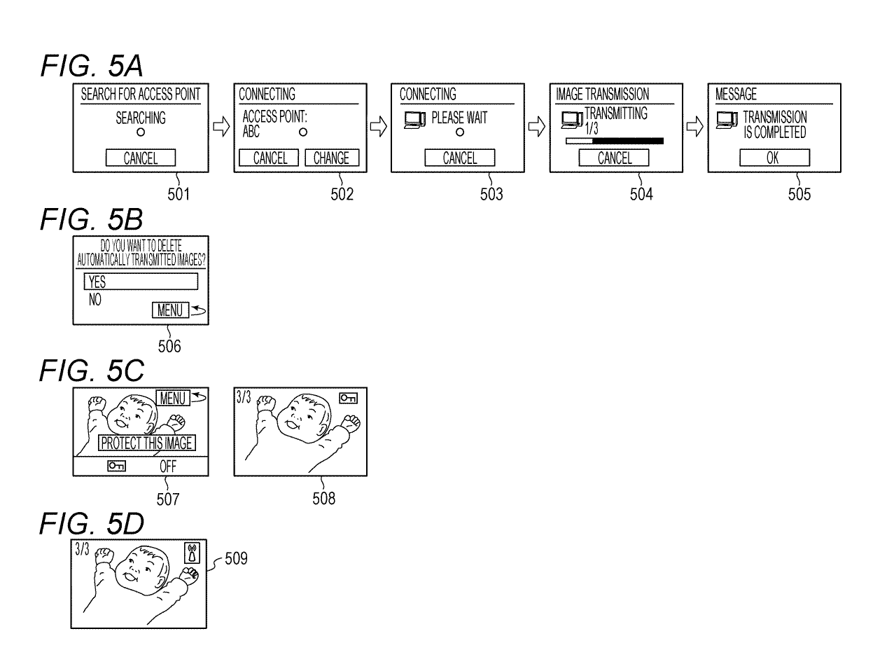

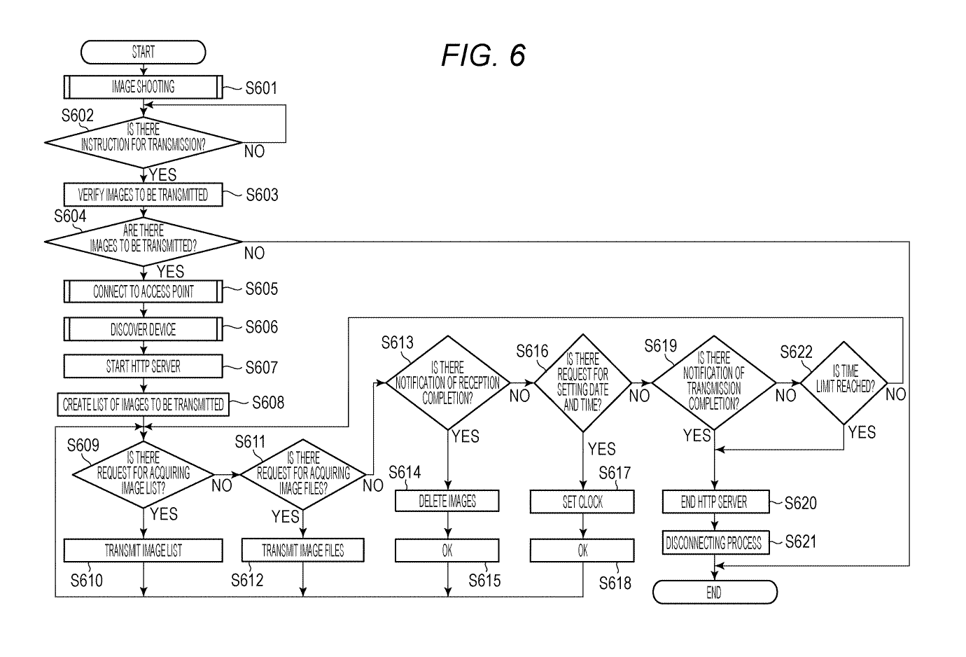

FIGS. 5A to 5D are diagrams illustrating GUIs displayed on the display unit 130 of the digital camera 100 at the time of image transmission according to one or more aspects of the present disclosure.

First, at S401, the control unit 101 detects that an instruction for starting communication with another apparatus has been provided. In this case, a specific operation unit assigned the role of providing an instruction for transmission may be prepared so that the control unit 101 can detect the unit's operation or the control unit 101 may accept the instruction for transmission via the user's menu operation or the like.

At S402, the control unit 101 of the digital camera 100 verifies whether there exists in the recording medium 141 any image file to be transmitted to the PC 200a. In the example, the header of an image file has a region prepared for recording transmission status and recording status information on whether the image file has been transmitted to the PC 200a. This region may be Makernote in Exchangeable image File format (Exif), for example. The control unit 101 of the digital camera 100 refers to the transmission status of the image files to determine whether the image files have been already transmitted. The method for transmission management is not limited to the foregoing one. For example, the control unit 101 can generate a management file recording the transmission status of the image files saved in the recording medium 141 and refer to the management file at step S402 to determine whether the image files have been already transmitted.

When detecting that there is any image file to be transmitted at S402, the control unit 101 of the digital camera 100 connects to the local area network built by the router 300 at S403. For example, the control unit 101 displays a GUI for accepting input of information necessary to the network connection on the display unit 130. Specifically, the control unit 101 displays on the display unit 130 a GUI having text boxes for inputting the SSID and the encryption key necessary for wireless connection to the router 300 building the LAN. When detecting that the information necessary for the network connection has been input, the control unit 101 displays a GUI 501 illustrated in FIG. 5A on the display unit 130 to execute the network connection.

The SSID is an identifier of an access point in a wireless LAN in IEEE802.11x series and is a name given to avoid interference. The encryption key is a key for encrypting the communication content to prevent unauthorized access to the SSID. The user inputs the SSID and the encryption key by operating a software keyboard displayed on the display unit 130 with the operation unit 102, for example. As a matter of course, the input method is not limited to this but any other input method such as a hardware keyboard or audio input can be used. As for the once connected access point, the SSID and the encryption key may be stored so the stored SSID and encryption key can be used to start automatically connection for next and subsequent times. In this case, when a plurality of SSIDs and encryption keys is stored, only the SSID may be selected or the SSID and the encryption key of the access point stored in advance in the recording medium 141 may be used to start automatically connection.

The control unit 101 stores temporarily the input or read SSID and encryption key in the memory 104 and establishes wireless connection with the router 300. Until completion of establishment of wireless communication, the control unit 101 displays a GUI 502 illustrated in FIG. 5A on the display unit 130. Upon completion of establishment of wireless connection with the router 300, the router 300 assigns the IP address to the digital camera 100. The control unit 101 saves the assigned IP address in the memory 104. Accordingly, the connection to the local area network (S403) is completed.

At S404, the control unit 101 of the digital camera 100 performs device discovery. The discovery at this step is carried out using discovery protocols such as Simple Service Discovery Protocol (SSDP) and MulticastDNS. The SSDP is a publicly known protocol for searching and discovering devices supporting UPnP on a network. MulticastDNS is a publicly known protocol for searching and discovering devices supporting Bonjour on a network.

The device discovery is intended for the digital camera 100 and the PC 200a to communicate with each other to recognize mutually that they are devices capable of image transmission. In addition, until completion of the device discovery, the control unit 101 displays a GUI 503 illustrated in FIG. 5A on the display unit 130.

First, as a sequence of the PC 200a recognizing that the digital camera 100 is a communicable device, a sequence with an advertising process of the digital camera 100 as a trigger will be described.

The control unit 101 of the digital camera 100 executes the advertising process. When the control unit 101 multicasts the presence of the digital camera 100 to the devices on the LAN, the presence of the digital camera 100 is notified to the devices (including the PC 200a) connected to the LAN to which the digital camera 100 is connected. The CPU 203 of the PC 200a receives an advertising message from the digital camera 100. Then, the CPU 203 determines from the information included in the advertising message whether the digital camera 100 is a target device for which the CPU 203 searches. Specifically, the advertising message includes information on the device type indicating what kind of the device it is and the service type indicating what function can be provided by the device. When determining that the digital camera 100 is a target device from the device type and the service type, the CPU 203 transmits a request for acquiring the device information. Specifically, when the discovery protocol is UPnP, the CPU 203 executes HTTP GET to request for a description, and when the discovery protocol is Bonjour, the CPU 203 requests for a TXT record. In response to the request for acquisition, the control unit 101 of the digital camera 100 transmits the device information to the PC 200a. The description includes information on the device's name, the manufacturer's name, the device's Universally Unique Identifier (UUID) indicating the individual information on the device, and the service name indicating the function capable of being provided by the device.

Next, the CPU 203 of the PC 200a checks the secondary storage device 205 to determine whether the digital camera 100 is connectable to the PC 200a based on the device information acquired from the digital camera 100. In the example, the device information includes the service name indicating that the digital camera 100 has the image transmission function. The PC 200a stores the service names in advance in the secondary storage device 205.

The CPU 203 compares the service name acquired with reference to the device information to the service name stored in the secondary storage device 205. When there is a match between the two, the CPU 203 determines that the digital camera 100 is connectable to the PC 200a. The sequence with the advertising process of the digital camera 100 as a trigger has been described so far.

Next, a sequence with the search process of the PC 200a as a trigger will be described.

The CPU 203 multicasts a search message to the network to which the PC 200a is connected to inquire whether there exists any device with a specific device type and service type. The search message includes information on the specified device type and service type. According to this multicast, the search message is sent to the devices (including the digital camera 100) connected to the LAN to which the PC 200a is connected.

The control unit 101 of the digital camera 100 receives the search message and determines whether there is a match between the specified device type and service type and the device type and the service type stored in advance in the recording medium 141 of the digital camera 100. When there is a match between them, the control unit 101 transmits a response to the PC 200a.

The CPU 203 determines from the information included in the response whether the digital camera 100 is a target device for which the CPU 203 searches. Specifically, when determining from the device type and service type included in the response that the digital camera 100 is the target device to be searched, the CPU 203 transmits a request for acquiring the device information. The subsequent procedure from the transmission of the request for acquiring the device information to the determination by the CPU 203 that the digital camera 100 is a communicable device is as described above.

The sequence with the search process of the PC 200a as a trigger has been described so far.

In the foregoing description, the PC 200a recognizes that the digital camera 100 is a communicable device. No communication is allowed unless the digital camera 100 similarly recognizes that the PC 200a is a communicable device.

Next, as a sequence of the digital camera 100 recognizing that the PC 200a is a communicable device, first, a sequence with an advertising process of the PC 200a as a trigger will be described.

The CPU 203 of the PC 200a multicasts an advertising message to notify the presence of the PC 200a to the devices on the LAN. Accordingly, the presence of the PC 200a is notified to the devices (including the digital camera 100) connected to the LAN to which the PC 200a is connected.

Next, upon receipt of the advertising message from the PC 200a, the control unit 101 of the digital camera 100 transmits a request for acquiring the device information to the PC 200a. Specifically, when the discovery protocol is UPnP, the control unit 101 executes HTTP GET to request for a description, and when the discovery protocol is Bonjour, the control unit 101 requests for a TXT record.

Next, the CPU 203 of the PC 200a transmits the device information to the digital camera 100 in response to the acquisition request. The control unit 101 compares the service name included in the device information to the service name stored in the recording medium 141 to determine whether the PC 200a is a device connectable to the digital camera 100. When there is a match between the two, the control unit 101 determines that the PC 200a is communicable. The sequence with the advertising process of the PC 200a as a trigger has been described so far.

Next, a sequence with the search process of the digital camera 100 as a trigger will be described.

The control unit 101 of the digital camera 100 multicasts a search message to the network to which the digital camera 100 is connected to inquire whether there exists any device with a specific device type and service type. According to this multicast, the search message is sent to the devices (including the PC 200a) connected to the LAN to which the digital camera 100 is connected.

The CPU 203 of the PC 200a determines whether there is a match between the specified device type and service type included in the received search message and the device type and the service type stored in advance in the secondary storage device 205 of the PC 200a. When there is a match between them, the CPU 203 transmits a response to the digital camera 100.

Upon receipt of the response from the PC 200a, the control unit 101 of the digital camera 100 transmits a request for acquiring the device information to the PC 200a.

The subsequent procedure from the transmission of the request for acquiring the device information to the determination by the control unit 101 that the PC 200a is a communicable device is as described above.

The sequence with the search process of the digital camera 100 as a trigger has been described so far.

According to one or more aspects of the present disclosure, it is possible to determine from the device type and service type whether the device is communicable without having to refer to the service name in the device information. For example, since the communication method may vary depending on different versions of the same function, the device information may be referred to obtain the detailed information on the function, and the device type and the service type may be referred to recognize only the presence or absence of the function.

When at least either the digital camera 100 or the PC 200a determines that the other is a connectable device, S405 and subsequent steps are not carried out.

At S405, the control unit 101 of the digital camera 100 determines that the PC 200a is a PC capable of paring and executes the HTTP server function. Then, the control unit 101 prepares for receiving a request from the PC 200a operating as an HTTP client.

At S406, the control unit 101 of the digital camera 100 generates a list of providable image files. This list can be generated in Extensible Markup Language (XML), for example.

At S407, the CPU 203 of the PC 200a requests for acquiring the list of image files providable by the digital camera 100. Specifically, the CPU 203 of the PC 200a executes as an HTTP client HTTP Get method on the digital camera 100 as the HTTP server. The location of the list is described in the device information acquired as Uniform Resource Identifier (URI) by the device discovery at S404.

At S408, the control unit 101 of the digital camera 100 serving as the HTTP server transmits the list of image files providable by the digital camera 100 to the PC 200a. As described above, the list is described in XML, for example, and includes the respective URIs of the image files providable by the digital camera 100.

At S409, the CPU 203 of the PC 200a acting as the HTTP client analyzes the acquired list of image files providable by the digital camera 100. The CPU 203 transmits to the digital camera 100 a request for acquiring one of the image files included in the list and identified by the analysis. Specifically, the CPU 203 of the PC 200a executes HTTP Get method with the URI of the image file included in the list as an access destination.

At S410, the control unit 101 of the digital camera 100 transmits the image file specified by the URI to the PC 200a.

At S411, upon completion of the receipt of the image file, the CPU 203 of the PC 200a acting as the HTTP client deletes the URI of the image file having been transmitted from the list of the image files, and transmits a request for notification of completion of receipt to the digital camera 100. Specifically, the CPU 203 of the PC 200a executes HTTP POST method indicating the completion of receipt.

At S412, the control unit 101 of the digital camera 100 deletes the image file having been transmitted. For the image deletion at S614, the user's confirmation can be input from the setting menu of the digital camera 100 in the GUI 506 illustrated in FIG. 5B.

At S413, the control unit 101 of the digital camera 100 returns a response to the request for notification of reception completion received at S411.

The CPU 203 of the PC 200a and the control unit 101 of the digital camera 100 repeat steps S409 to S413 until the PC 200a acquires all the image files included in the list. During the transmission of the image files, the control unit 101 displays a GUI 504 illustrated in FIG. 5A on the display unit 130 to indicate the status of the image transmission. Specifically, the control unit 101 displays the number of the images to be transmitted, the number of the images having been transmitted at present, and the progress of the transmission.

The feature of steps S409 to S413 is in that, upon each reception of a notification of reception completion of one image file, the corresponding image file is deleted from the digital camera 100 even though a plurality of image files is included in the list of the image files. As described above, the image files of affected areas shot in medical settings, for example, are desirably deleted immediately after being transmitted to the PC 200a. Accordingly, in one or more aspects of the present disclosure, each time when the PC 200a receives one image file, the PC 200a transmits a notification of reception completion and the digital camera 100 deletes the corresponding image file, and after the completion of the deletion, the next image is subjected to the transmission process. This configuration makes it possible to delete the image files transmitted to the PC 200a quickly from the digital camera 100.

At S414, the clock in the digital camera 100 is adjusted. Specifically, the CPU 203 of the PC 200a acting as the HTTP client transmits date-and-time information held in the PC 200a to the digital camera 100. More specifically, as the HTTP client, the CPU 203 of the PC 200a executes HTTP Post method on the digital camera 100 as the HTTP server. The date-and-time information may be Coordinated Universal Time (UTC) or local time including time difference information.

At S415, the control unit 101 of the digital camera 100 stores the received date-and-time information held by the PC 200a in the recording medium 141 to change the setting of the date-and-time information in the digital camera 100.

At S416, the control unit 101 of the digital camera 100 returns a response to the request for a notification of reception completion received at S414.

By performing steps S414 to S416, the adjustment to the clock in the digital camera 100 is completed. The clock is adjusted in this sequence because the image files of affected areas shot in medical settings, for example, are managed in time series and it is desired that the images are always shot and recorded in files at correct time.

In this sequence, the date-and-time information is set after the completion of transmission of the image files but may be set before the transmission of the image files. In addition, when there is no image file to be transmitted in the recording medium 141 but the instruction for transmission is provided at S401, the digital camera 100 may connect to the PC 200a to set only the date-and-time information.

At S417, when all the URIs of the image files are deleted from the list of the image files, the CPU 203 of the PC 200a notifies the digital camera 100 that all the image files have been acquired.

At S418, the control unit 101 of the digital camera 100 returns a response to the request at S417 and displays a GUI 505 illustrated in FIG. 5A on the display unit 130.

At S419, upon receipt of a notification of acquisition completion, the control unit 101 of the digital camera 100 ends the function of the HTTP server and disconnects from the network.

The operations of the digital camera 100, the PC 200a, and the server 200b in the discovery process sequence have been described so far.

### <Operations of the Digital Camera in the Image Transmission Sequence>

The operations of the digital camera 100 in the image transmission sequence described above will be described in detail with reference to the flowchart described in FIG. 6.

At S601, the digital camera 100 shots images and saves image files in the recording medium 141.

At S602, the control unit 101 determines whether an instruction for transmission has been detected. This step corresponds to S401 described in FIG. 4. The control unit 101 moves to S603 when the instruction for transmission has been detected, and the control unit 101 repeats this step when no instruction for transmission has been detected.

At S603, the control unit 101 checks whether there is any image to be transmitted in the image files in the recording medium 141. This step corresponds to S402 described in FIG. 4.

At S604, the control unit 101 determines whether there is any image to be transmitted. The control unit 101 moves to S605 when determining that there is any image to be transmitted. The control unit 101 ends the process when not determining that there is any image to be transmitted. Alternatively, even when not determining that there is any image to be transmitted, the control unit 101 may move to S616 to set the date and time as described later.

At S605, the control unit 101 connects to the local area network built by the router 300. This step corresponds to S403 described in FIG. 4.

At S606, the control unit 101 conducts device discovery. This step corresponds to S404 described in FIG. 4.

At S607, the control unit 101 activates the HTTP server function. This step corresponds to S405 described in FIG. 4. In one or more aspects of the present disclosure, the control unit 101 activates the HTTP server function after determining that the PC 200a is a connectable device. However, when the HTTP client (the PC 200a) transmits a request before the completion of activation of the HTTP server, the digital camera 100 may not make a response. Accordingly, the control unit 101 may activate the HTTP server function at the point in time when the connection to the LAN is established at S605.

At S608, the control unit 101 creates a list of images to be transmitted. This step corresponds to S406 described in FIG. 4.

At S609, the control unit 101 determines whether a request for acquiring the list of images to be transmitted has been received. The control unit 101 moves to S610 when the request has been received.

At S610, the control unit 101 transmits the list of image files to be transmitted in response to the request from the PC 200a. This step corresponds to S408 described in FIG. 4.

At S611, the control unit 101 determines whether a request for acquiring an image file has been received. The control unit 101 moves to S612 when the request has been received.

At S612, the control unit 101 transmits the image file in response to the request from the PC 200a. This step corresponds to S410 described in FIG. 4.

At S613, the control unit 101 determines whether a notification of reception completion of one image file has been received. The control unit 101 moves to S614 when the notification has been received.

At S614, the control unit 101 deletes the image file that has been transmitted. This step corresponds to S412 described in FIG. 4.

At S615, the control unit 101 returns a response to the request made at S613. This step corresponds to S413 described in FIG. 4.

At S616, the control unit 101 detects whether a request for setting the date-and-time information has been received. The control unit 101 moves to S617 when the request has been received.

At S617, the control unit 101 sets the date-and-time information. This step corresponds to S415 described in FIG. 4.

At S618, the control unit 101 returns a response to the request made at S616. This step corresponds to S416 described in FIG. 4.

At S619, the control unit 101 detects whether a notification of transmission completion has been received. The control unit 101 moves to S620 when the notification has been received.

At S620, the control unit 101 ends the function of the HTTP server. This step corresponds to S419 described in FIG. 4.

At S621, the control unit 101 disconnects from the network and ends the process.

At S622, the control unit 101 determines whether the time limit for accepting a request has been passed. When having not received as the HTTP server a request from the PC 200a for a specific period of time, the control unit 101 moves to S620 to end the process. In the other situation, the control unit 101 waits for a request from the PC 200a.

The operations of the digital camera 100 in the image transmission sequence according to one or more aspects of the present disclosure have been described so far.

As described above, according to one or more aspects of the present disclosure, it is possible to back up the image files in the PC in a reliable manner. In addition, after the completion of the backup of the image files, the image files can be deleted at once from the digital camera. Further, setting the date-and-time information at each connection makes it possible to keep the correct date and time in the digital camera.

In relation to one or more aspects of the present disclosure, the communication method by which the digital camera 100 transmits the list of image files to be transmitted to the PC 200a and the PC 200a specifies the image file and requests for the same has been described. However, the present disclosure is not limited to this. For example, the digital camera 100 may manage the image files and determine whether they have been transmitted to the PC 200a, and transmit an image file to be transmitted in response to a request for the image file from the PC 200a or in a push format.

### Second Embodiment

In relation to the first embodiment, descriptions have been given as to the mode in which the image files are deleted at once from the digital camera when the image files of the digital camera 100 are backed up in the PC 200a. However, when an image file is protected (the image file is given a protection attribute), the user does not intend to delete the image file, and the image file is difficult to handle.

In relation to one or more aspects of the present disclosure, a description will be given as to operations of the digital camera 100 in the case where an image file is protected and cannot be deleted. The following description is based on the assumption that three image files to be transmitted are saved in the recording medium 141 of the digital camera 100 and one of them is protected. An image file can be protected from a protection setting menu in a GUI 507 illustrated in FIG. 5C, for example. When the protected image file is reproduced, an icon indicative of the protection is displayed on the upper right side of a GUI as with a GUI 508 illustrated in FIG. 5C. The scope of the protection is applicable to operations related to editing and deletion of an image file, and specific information in the image header such as transmission completion information can be changed.

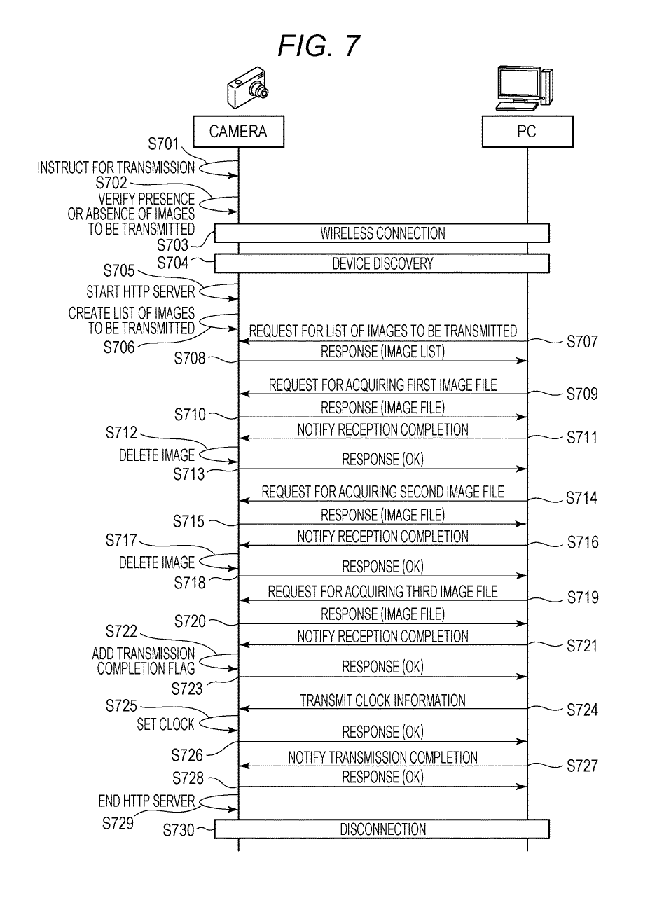

FIG. 7 is an operational sequence diagram of the digital camera 100 and the PC 200a according to one or more aspects of the present disclosure. In FIG. 7, the same operations as those described in FIG. 4 are given the same reference signs as those in FIG. 4 and descriptions thereof will be omitted.

S701 to S708 are the same as S401 to S408 and descriptions thereof will be omitted.

S709 to S713 and S714 to S718 are the same as S409 to S413 and descriptions thereof will be omitted.

S719 to S721 and S723 are the same as S409 to S411 and S413 and descriptions thereof will be omitted.

At S717, when detecting that the image file is protected, the control unit 101 of the digital camera 100 does not delete the image file but records the transmission completion information in the image file. As a different method, the control unit 101 may generate a management file of transmission status of the image files saved in the recording medium 141 and rewrite the information to indicate the transmission completion. When the image with the transmission completion information is displayed on the display unit 130 of the digital camera 100, an icon indicating that the transmission completion is also displayed on the upper right side of a GUI as with a GUI 509 illustrated in FIG. 5D.

S724 to S730 are the same as S414 to S420 and descriptions thereof will be omitted.

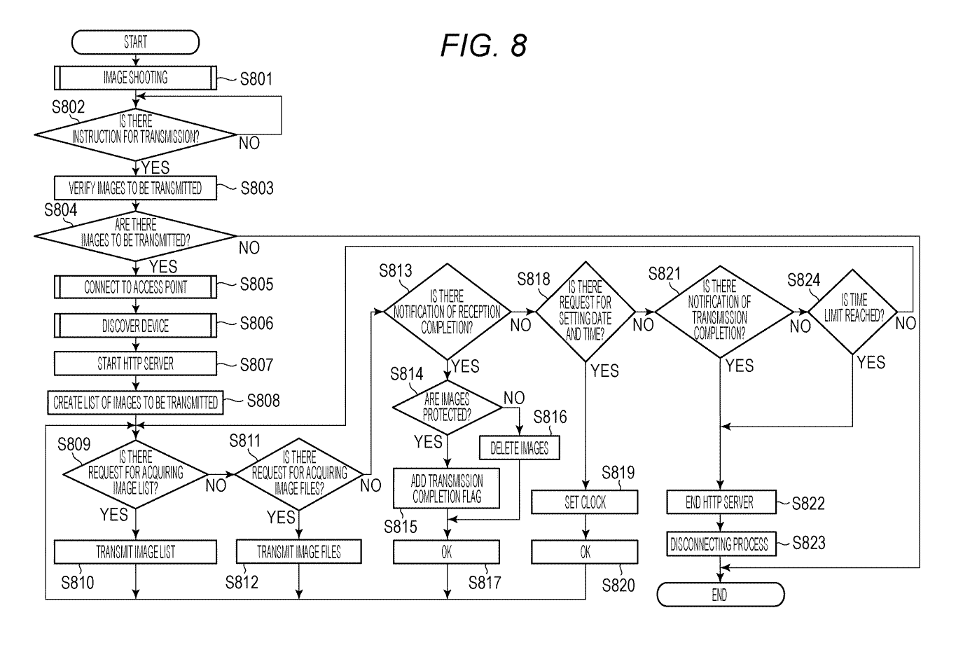

FIG. 8 is a flowchart of operations of the digital camera 100 in the sequence chart of FIG. 7. In FIG. 8, the same operations as those described in FIG. 6 are given the same reference signs as those in FIG. 6 and descriptions thereof will be omitted.

S801 to S813 and S818 to S824 are the same as S601 to S613 and S616 to S622 and descriptions thereof will be omitted.

At S814, the control unit 101 of the digital camera 100 detects whether an image file is protected.

At S815, when the image file is protected, the control unit 101 of the digital camera 100 records the transmission completion information in the image file.

At S816, when the image file is not protected, the control unit 101 of the digital camera 100 deletes the image file.

In one or more aspects of the present disclosure, the process performed on the image file varies between the case in which the image file is protected and the case in which the image file is not protected. As another possible method, the control unit 101 records the transmission completion information in all the image files and deletes the unprotected image file afterward.

S817 is the same as S615 and descriptions thereof will be omitted. The operations of the digital camera 100 in the case where the image file is protected and cannot be deleted have been described so far.

As described above, even though there is any protected image file, the transmission completion information is recorded in the image file so that the already transmitted image file will not be listed as a transmission target at the next and subsequent image transmissions. In addition, the user can operate the digital camera as necessary to unprotect the image file and delete manually the image file, thereby achieving the same effects as those of the first embodiment.

### Third Embodiment

This embodiment will be described taking a system including a digital camera, a server, and a digital photo storage as an example. The digital photo storage and the server in this system are both configured basically in the same manner as the personal computer illustrated in FIG. 2. Some of the components identical to those of the foregoing embodiments will be not described below.

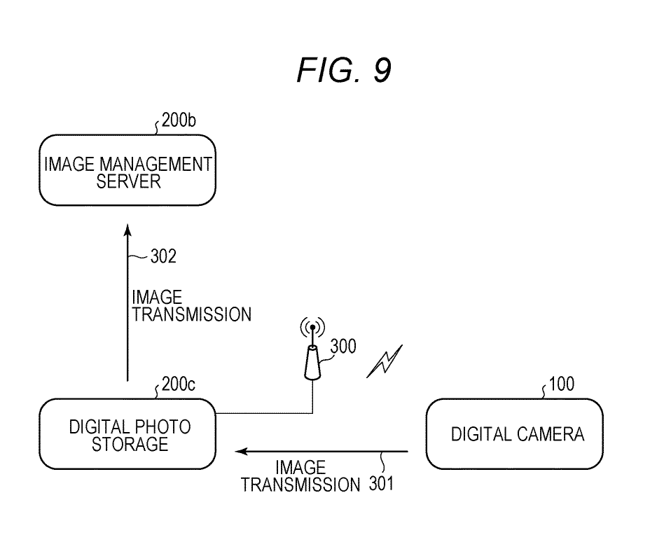

FIG. 9 is a schematic diagram illustrating a connection mode of the digital camera 100, the server 200b, and a digital photo storage 200c according to one or more aspects of the present disclosure.

The digital photo storage 200c can connect to an LAN built by the router 300 and connect to a WAN through the router 300 to communicate with the server 200b on the WAN.

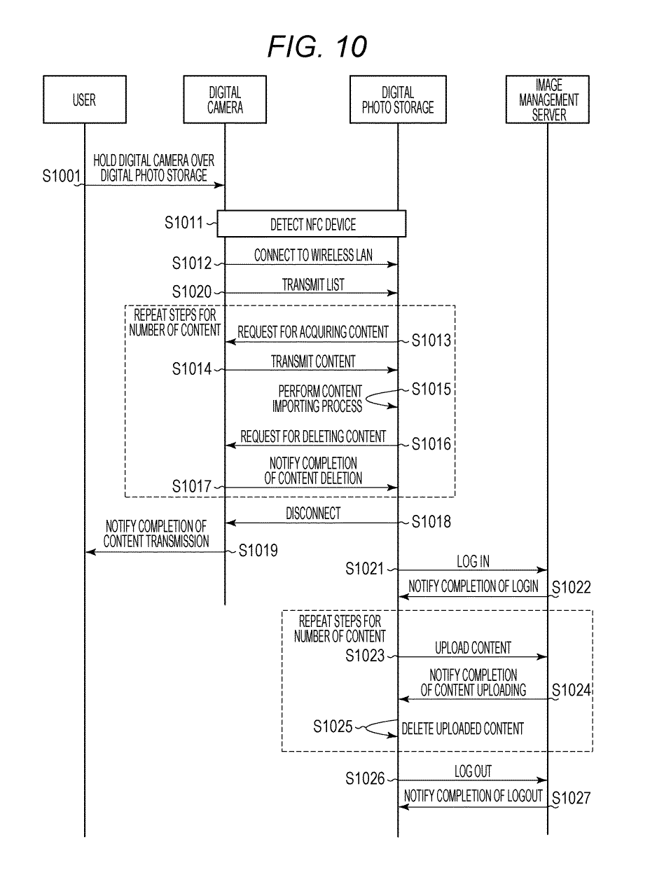

The digital photo storage 200c according to one or more aspects of the present disclosure implements the (handover) function of detecting the digital camera 100 by NFC and switching to wireless LAN communication. The process of switching from the NFC communication to the wireless LAN connection will be described in detail in relation to S1011 in FIG. 10 described later. In addition, the digital photo storage 200c can have the device discovery function by UPnP, for example, to discover devices in the network and establish communications with the devices. The present disclosure is not limited to the foregoing communication protocol but can be carried out in communications using other protocols.

By the foregoing process, the digital camera 100 and the digital photo storage 200c can establish the wireless LAN communication to transmit image files from the digital camera 100 to the digital photo storage 200c.

Further, the secondary storage device 205 of the digital photo storage 200c according to one or more aspects of the present disclosure has a program installed to allow communication with the digital camera 100 in conformity with PTP-IP.

<Sequence of Image Transmission from the Camera Through the Photo Storage to the Server>

Next, a description will be given as to a sequence of transmitting the image files saved in the recording medium 141 of the digital camera 100 to the digital photo storage 200c by the communication 301 and transmitting the same from the digital photo storage 200c to the server 200b by the communication 302.

The operations of the digital camera 100 in the sequence and the flowchart described below are implemented by the control unit 101 controlling the components of the digital camera 100 in accordance with the program. The operations of the digital photo storage 200c and the server 200b are implemented by the respective CPUs 203 controlling the components of the digital photo storage 200c and the server 200b in accordance with the program.

FIG. 10 is an operational sequence diagram of the digital camera 100, the digital photo storage 200c, and the image management server 200b according to one or more aspects of the present disclosure. This sequence is started when the user of the digital camera 100 has performed image shooting and a plurality of images is saved in the recording medium 141.

At S1001, the user of the digital camera 100 holds the digital camera 100 over the digital photo storage 200c to transmit the plurality of image files saved in the recording medium 141 to the digital photo storage 200c. Accordingly, an NFC reader/writer in the communication device 206 of the digital photo storage 200c and an NFC tag in the communication device 152 of the digital camera 100 come close to each other in the communication range.

At S1011, the digital photo storage 200c detects the presence of the digital camera 100 and starts NFC communication. The digital photo storage 200c acquires camera information by the NFC reader from the digital camera 100 and determines based on the camera information whether the detected digital camera 100 is a communicable and compatible model. When determining that the digital camera 100 is a compatible model, the digital photo storage 200c writes by the NFC writer device information stored in the secondary storage device 205 and wireless LAN connection information into the NFC tag of the digital camera 100. The control unit 101 of the digital camera 100 acquires the device information and the wireless LAN connection information of the digital photo storage 200c from the NFC tag in the communication unit 152. When determining that the communication with the digital photo storage 200c is enabled from the acquired device information and wireless LAN connection information of the digital photo storage 200c, the control unit 101 of the digital camera 100 writes the information on the communicable state into its own NFC tag. Meanwhile, the digital photo storage 200c periodically reads the NFC tag of the digital camera 100 by the NFC reader to acquire the information on the communicable state of the digital camera 100. When the digital photo storage 200c cannot acquire the information on the communicable state from the NFC tag of the digital camera 100 within a specific period of time, the digital photo storage 200c determines that the digital camera 100 is in the incommunicable state and completes the process.

When detecting from the NFC tag of the digital camera 100 that the digital camera 100 is in the communicable state, the digital photo storage 200c also enters the communicable state.

When the information indicating the communicable state is written into the NFC tag, the digital camera 100 activates the wireless LAN unit of the communication device 206 at S1012 to connect to the wireless LAN network using the address and the SSID as the information acquired from the digital photo storage 200c. Then, after the digital camera 100 connects to the wireless LAN network, the digital camera 100 and the digital photo storage 200c discover each other using the discovery protocol to establish PTP-IP communication. Accordingly, the digital camera 100 and the digital photo storage 200c are allowed to transmit and receive pieces of content therebetween. The specific sequence of transmission and reception of pieces of content will be described below.

At S1020, the digital camera 100 transmits its own list of image files to the digital photo storage 200c. The list includes IDs of the image files (for example, file names and object handles). The digital photo storage 200c can request the digital camera 100 for a specific image file based on this list.

At S1013, the digital photo storage 200c specifies specific one of the image files saved in the recording medium 141 of the digital camera 100 and requests the digital camera 100 for the image file.

At S1014, the digital camera 100 transmits the image file requested at S1013 to the digital photo storage 200c.

At S1015, the digital photo storage 200c receives the image file through the communication device 206, and saves the same in the secondary storage device 205. Further, the digital photo storage 200c registers the information in the saved image file in a file management table stored in the secondary storage device 205. The file management table allows the digital photo storage 200c to manage the received images.

After completion of the registration at S1015, the digital photo storage 200c transmits a request for deleting the image file to the digital camera 100 at S1016.

At S1017, the digital camera 100 deletes the image file of which deletion is requested by the digital photo storage 200c and transmits a notification of deletion completion indicating the result to the digital photo storage 200c. In one or more aspects of the present disclosure, even though the protection attribute is added to the image file of which deletion is requested, the digital camera 100 ignores the attribute and deletes the image file.

After receipt of the notification of deletion completion transmitted at S1017, the digital photo storage 200c returns the process to S1013 to perform the same process on the next image file. In this manner, the digital photo storage 200c repeatedly executes S1013 to S1017 on the image files existing in the digital camera 100. As a result, all the image files shot by the digital camera 100 are transmitted to the digital photo storage 200c, and all the transmitted image files are deleted from the digital camera 100.

At S1018, the digital photo storage 200c disconnects from the digital camera 100.

At S1019, the digital camera 100 displays a GUI on the display unit 130 to notify the user that the image files have been completely transmitted to the digital photo storage 200c.

The process of transmitting the image files from the digital camera 100 to the digital photo storage 200c has been described so far. The process of transmitting the images from the digital photo storage 200c to the server 200b will be described below. The process may automatically move from step S1019 to step S1021, or the process may be stopped once at S1019 and then S1021 and the subsequent steps may be started with a predetermined trigger such as user operation, for example.

At S1021, the digital photo storage 200c logs in to the server 200b by the communication device 206. In response to this, at S1022, the server 200b returns a notification of completion to the digital photo storage 200c.

At S1023, the digital photo storage 200c specifies one of the image files received from the digital camera 100 and uploads the same to the server 200b. In one or more aspects of the present disclosure, the image files are uploaded to the digital photo storage 200c and the server 200b under File Transfer Protocol (FTP). However, the present disclosure is not limited to this but the upload may be performed using other communication protocols.

At S1024, in response to the upload of the image file from the digital photo storage 200c, the server 200b receives the image file via its communication device 206, and saves the same in the secondary storage device 205 through the primary storage device 204. After completion of the saving of the image file received from the digital photo storage 200c, the server 200b sends a notification of completion of receipt of the image file (a notification of upload completion) to the digital photo storage 200c.

At S1025, the digital photo storage 200c deletes the image file having been completely uploaded from its secondary storage device 205.

The digital photo storage 200c repeatedly executes S1023 to S1025 for a number of image files received from the digital camera 100 (that is, a number of image files saved in the secondary storage device 205). As a result, all the plurality of image files saved in the digital photo storage 200c is transmitted to the server 200b, and all the transmitted image files are deleted from the secondary storage device 205 of the digital photo storage 200c.

At S1026, the digital photo storage 200c logs out from the server 200b. At S1027, the digital photo storage 200c and the server 200b are disconnected from each other.

The sequence of transmitting the image files saved in the digital camera 100 to the digital photo storage 200c and transmitting the same from the digital photo storage 200c to the server 200b has been described so far. By the foregoing process, the image files uploaded to the server 200b are deleted from both the digital camera 100 and the digital photo storage 200c. This means that the image files are disposed of in an appropriate manner.

### <Operations of the Digital Photo Storage in the Image Transmission Sequence>

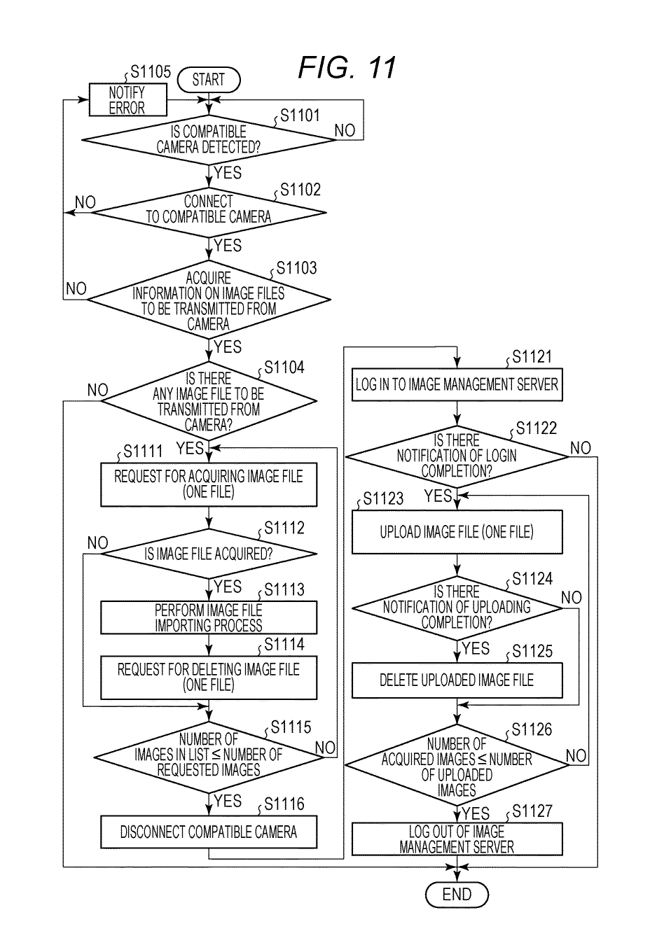

The operations of the digital photo storage 200c in the image transmission sequence described above with reference to FIG. 10 will be described in detail with reference to the flowchart in FIG. 11.

At S1101, the CPU 203 and the communication device 206 of the digital photo storage 200c perform the process of detecting a camera compatible with the digital photo storage 200c by regular checkups. In one or more aspects of the present disclosure, when a digital camera compatible with the digital photo storage 200c comes close to the NFC communication range, the digital photo storage 200c detects the compatible camera. This step corresponds to S1001 and S1011 described in FIG. 10. When the compatible camera is detected by the foregoing detection, the process moves to S1102.

At S1102, the CPU 203 and the communication device 206 of the digital photo storage 200c perform the connection process to enable transmission and reception of image files to and from the detected compatible camera. This step corresponds to S1012 described in FIG. 10. When the connection has succeeded, the process moves to S1103.

At S1103, the CPU 203 and the communication device 206 of the digital photo storage 200c acquire information on the (plurality of) image files (such as the number of the files) transmitted from the connected compatible camera. This step corresponds to S1020 in FIG. 10. The acquired image file information is saved in the secondary storage device 205. When the acquisition of the image file information has succeeded, the process moves to S1104.

When the connection with the compatible camera failed and the acquisition of the image file information failed at S1102 and S1103, the process moves to S1105 to make an error notification to the user. The error notification may be made by displaying a GUI on the video output unit 208 or the display unit 201, or by using the color or blinking period of a power lamp included in the main body, for example.

At S1104, when it is determined based on the acquired image file information that there exists any image file to be transmitted from the compatible camera (the number of the file(s) is larger than 0), the process moves to S1111. When the number of image file to be transmitted from the compatible camera is 0, the process is ended.

At S1111, the CPU 203 and the communication device 206 of the digital photo storage 200c make a request for acquiring each one of the image files to the compatible camera. This step corresponds to S1013 described in FIG. 10.

At S1112, the communication device 206 of the digital photo storage 200c receives the requested image files from the compatible camera and saves the same in the secondary storage device 205 through the primary storage device 204. This step corresponds to S1014 described in FIG. 10. When the acquisition of the image files has failed, it is determined at S1115 based on the image file information whether there exists any image file to be acquired next. When there exists any image to be acquired next, the process returns to S1111, and when there exists no image to be acquired next, the process moves to S1116.

At S1113, the CPU 203 and the primary storage device 204 of the digital photo storage 200c register the acquired image files in the file management table saved in the secondary storage device 205. This step corresponds to S1015 described in FIG. 10.

At S1114, the CPU 203 and the communication device 206 of the digital photo storage 200c make a request for deleting the image files to the compatible camera to delete the image files received and registered in the file management table from the compatible camera. This step corresponds to S1016 described in FIG. 10.

At S1115, it is determined based on the image file information in the secondary storage device 205 whether there exists any image file to be acquired next. When it is determined that there exists any image file to be acquired next, the process returns to S1111, and when there exists no image file to be acquired next, the process moves to S1116.

At S1116, the CPU 203 and the communication device 206 of the digital photo storage 200c disconnects from the compatible camera. This step corresponds to S1018 described in FIG. 10.

The digital photo storage 200c repeatedly executes S1111 to S1114 for a number of image files existing in the compatible camera. As a result, the image files shot by the compatible camera are transmitted to the digital photo storage 200c, and the transmitted image files are deleted from the compatible camera.

At S1121, the communication device 206 of the digital photo storage 200c acquires connection information of the server 200b acquired or set in advance from the secondary storage device 205 to log in to the server 200b. This step corresponds to S1021 described in FIG. 10.

At S1122, the communication device 206 of the digital photo storage 200c acquires a notification of login completion from the server 200b. This step corresponds to S1022 described in FIG. 10. When the login has been normally completed, the process moves to S1123. When the login has been abnormally completed or has failed, login failure information (information for identifying the file that could not be uploaded due to the login failure) is described in the file management table, and the process is ended. Accordingly, the image files left in the digital photo storage 200c can be collectively uploaded as described later.

At S1123, the CPU 203 and the communication device 206 of the digital photo storage 200c upload the acquired image files one by one to the server 200b based on the acquired image file information and the file management table. This step corresponds to S1023 described in FIG. 10.

At S1124, the communication device 206 of the digital photo storage 200c receives the results of the upload from the server 200b. This step corresponds to S1024 described in FIG. 10. When the upload has failed, upload failure information is described in the file management table. This makes it possible to upload collectively the image files left in the digital photo storage 200c as described later. Further, when the upload has failed, it is determined at S1126 whether there exists any image file to be uploaded next. When there exists any image file to be uploaded, the process returns to S1123. When it is determined that there exists no image file to be uploaded, the process moves to S1127.

At S1125, the CPU 203 of the digital photo storage 200c deletes the uploaded image files from the secondary storage device 205 of the digital photo storage 200c. Further, the CPU 203 of the digital photo storage 200c also deletes the data on the uploaded image files from the file management table saved in the secondary storage device 205. This step corresponds to S1025 described in FIG. 10. In this example, the CPU 203 of the digital photo storage 200c deletes even any protected image files.

At S1126, it is determined based on the image file information and the file management table in the secondary storage device 205 whether there exists any image file to be uploaded next. When it is determined that there exists any image file to be uploaded next, the process returns to S1123, and when it is determined that there exists no image file to be uploaded next, the process moves to S1127.

The digital photo storage 200c repeatedly executes S1123 to S1126 for a number of the image files received from the compatible camera. As a result, the image files received from the compatible camera are transmitted to the server 200b, and the transmitted image files are deleted from the digital photo storage 200c.

At S1127, the digital photo storage 200c logs out from the server 200b. This step corresponds to S1026 described in FIG. 10.

The operation flow of the digital photo storage 200c in the sequence of transmitting the image files saved in the digital camera 100 to the digital photo storage 200c and transmitting the same from the digital photo storage 200c to the server 200b has been described so far.

### <Sequence of Transmitting the Image Files Left in the Photo Storage to the Server>

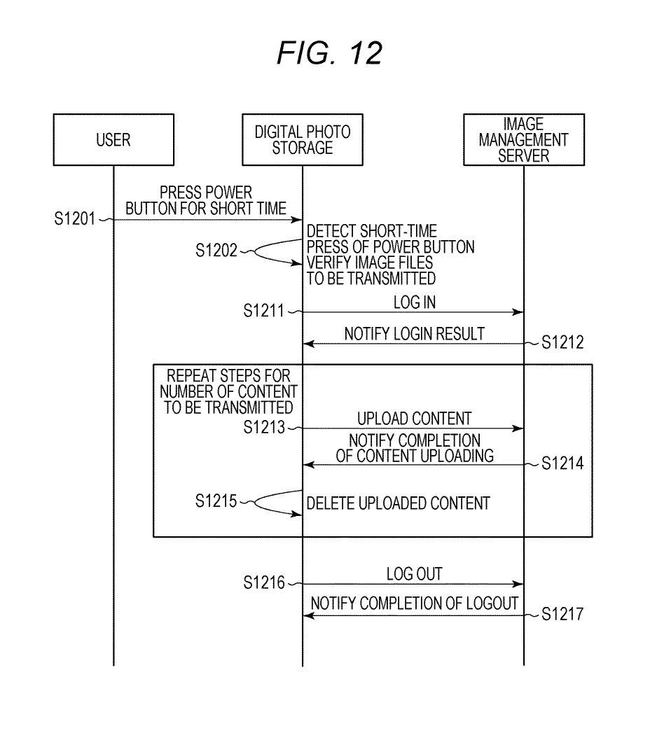

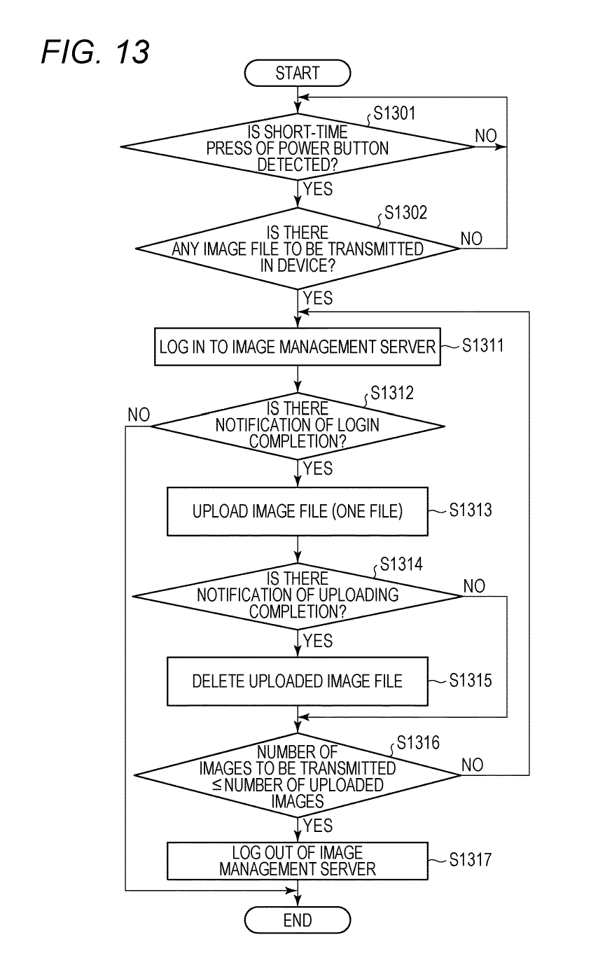

When the login to the server 200b failed at S1122 or the upload failed at S1124, the image files to be transmitted to the server 200b are left in the secondary storage device 205 of the digital photo storage 200c. Assuming such a case, it is possible to execute a process of re-transmitting the image files left in the digital photo storage 200c in one or more aspects of the present disclosure. The process will be described with reference to FIGS. 12 and 13.

FIG. 12 is an operational sequence diagram of the digital photo storage 200c retransmitting images to the server 200b at the time of image transmission according to one or more aspects of the present disclosure.

At S1201, the user depresses shortly a physical power button in the main body operation unit 202 of the digital photo storage 200c (the cancellation of the depression is detected within a predetermined period of time from the depression of the button). This constitutes a trigger for transmitting the image files to be transmitted left in the digital photo storage 200c to the server 200b. To power on or off the digital photo storage 200c according to one or more aspects of the present disclosure, the power button is depressed for a long time (the cancellation of the depression is not detected within a predetermined period of time from the depression of the button).

In one or more aspects of the present disclosure, the short-time depression of the power button in the digital photo storage 200c is set as a trigger for re-transmission. The trigger for re-transmission is here assigned to the physical button for powering on/off that would be surely included in every model of the digital photo storage 200c because some of the models do not have an operation unit with an abundance of buttons. However, the trigger for re-transmission may not be necessarily assigned to the power button but may be assigned to a remote operation from another operation unit or the outside.

When the short-time depression of the power button by the user is detected at S1202, the secondary storage device 205 in the digital photo storage 200c is referred to verify whether there exists any image file to be transmitted within the device.

At S1211, the digital photo storage 200c logs in to the server 200b by the communication device 206. In response to this, at S1221, the server 200b returns a notification of completion to the digital photo storage 200c. The connection method for the communication devices is a well-known technique and detailed descriptions thereof will be omitted as in the foregoing description with reference to FIG. 10.

Steps S1213 to S1217 are the same as steps S1023 to S1027 described in FIG. 10.

The sequence of the digital photo storage 200c transmitting the image files to be transmitted left in the digital photo storage 200c to the server 200b has been described so far.

### <Operations of the Digital Photo Storage in the Image Transmission Sequence Described in FIG. 12>

The operations of the digital photo storage 200c in the image transmission sequence described above with reference to FIG. 12 will be described in detail with reference to the flowchart described in FIG. 13.

At S1301, the operation unit 202 and the CPU 203 of the digital photo storage 200c regularly perform a power button short-time depression detection check process to determine whether the user has depressed the power button. When the short-time depression of the power button is detected in the power button short-time depression detection check process, the process moves to S1302. When the short-time depression of the power button is not detected, the power button short-time depression detection check process is continued on a regular basis.

At S1302, it is checked whether there exists any image file to be transmitted in the digital photo storage 200c. At this time, the digital photo storage 200c refers to the file management table saved in the secondary storage device 205 to verify whether there exists any image file to be transmitted to the server 200b based on the login failure information and the upload failure information. When it is verified that there exists any image file to be transmitted in the digital photo storage 200c, the process moves to S1311. When it is verified that there exists no image file to be transmitted in the digital photo storage 200c, the process returns to S1301 to detect the short-time depression of the power button. This step corresponds to S1202 described in FIG. 12.

Steps S1311 to S1317 are the same as steps S1121 to S1127 in FIG. 11.

In particular, at S1314, the CPU 203 of the digital photo storage 200c transmits the plurality of image files to be transmitted in the secondary storage device 205 one by one to the server 200b based on the login failure information and the upload failure information.

The flow of operations of the digital photo storage 200c in the sequence of transmitting the image files to be transmitted left in the digital photo storage 200c to the server 200b has been described so far. This makes it possible to transmit the image files to be transmitted left in the digital photo storage 200c to the server 200b.

### Other Embodiments

In the first and second embodiments, the digital camera 100 acts as the HTTP server when there exists the PC 200a capable of pairing with the digital camera 100 on the connected LAN, and the digital camera 100 acts as the HTTP client when there exists no PC 200a. Meanwhile, the PC 200a acts as the HTTP client at any time. Alternatively, the digital camera 100 may act as the HTTP client at any time, and the PC 200a may act as the HTTP server when there exists the digital camera 100 capable of pairing with the PC 200a on the connected network and may act as the HTTP client when there exists no digital camera 100.

In the foregoing embodiments, the connection between the digital camera and the PC or the digital photo storage is taken as an example. However, the types of the devices are not limited. The devices may be output devices such as printers or mobile terminals such as smartphones and tablets.

In the foregoing embodiments, the digital camera 100 with the built-in wireless communication function is taken as an example. Alternatively, a recording medium capable of wireless communications may be attached to the digital camera 100 to control wireless communications as the recording medium 141. In this case as well, the same control as that according to one or more aspects of the present disclosure is conducted on the wireless circuit unit of the recording medium capable of wireless communications.

Further, the present disclosure is also applicable to a system that remotely manipulates the digital camera 100 from a PC or the like. In this case, the control unit of the PC makes various inquiries and requests for control to the control unit 101 of the digital camera 100 to implement the remote control.

In the foregoing embodiments, the transmitted pieces of content are deleted. However, the method of disposing of the pieces of content is not limited to deletion. For example, the pieces of content may be encrypted to improve security and make more difficult access from the third parties.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application Nos. 2016-081375, filed Apr. 14, 2016, and 2016-137688, filed Jul. 12, 2016, which are hereby incorporated by reference herein in their entirety.

What is claimed is:

1. A communication apparatus, comprising:
a specifying unit configured to specify content to be transmitted to an external apparatus, out of pieces of content recorded in a recording medium;
a transmission unit configured to, when the specifying unit specifies a plurality of pieces of content, transmit first content out of the plurality of pieces of content to the external apparatus;
a reception unit configured to, after the transmission unit transmits the first content, receive a notification of receipt of the first content from the external apparatus; and
a deletion unit configured to, when the reception unit receives the notification of receipt of the first content from the external apparatus, delete the first content from the recording medium, wherein, after the deletion unit deletes the first content, the transmission unit transmits second content out of the plurality of pieces of content to the external apparatus.

2. The communication apparatus according to claim 1, wherein, the specifying unit specifies content not transmitted to the external apparatus as content to be transmitted to the external apparatus.

3. The communication apparatus according to claim 2, wherein when the transmission unit transmits protected content, the deletion unit does not delete the protected content even though the reception unit receives the notification.

4. The communication apparatus according to claim 3, further comprising a setting unit configured to, when the transmission unit transmits the protected content, set the protected content recorded in the recording medium as a transmitted content.

5. The communication apparatus according to claim 1, wherein the content is image data captured by an imaging unit.

6. The communication apparatus according to claim 1, wherein the communication apparatus is a digital camera.

7. The communication apparatus according to claim 1, wherein the communication apparatus uses Hyper Text Tranfer Protocol (HTTP) server function to communicate with the external apparatus acting as an HTTP client.

8. A control method for a communication apparatus, the method comprising:
a specification step of specifying content to be transmitted to an external apparatus, out of pieces of content recorded in a recording medium;
a first transmission step of, when a plurality of pieces of content is specified at the specification step, transmitting first content out of the plurality of pieces of content to the external apparatus;
a reception step of, after the first content is transmitted at the transmission step, receiving a notification of receipt of the first content from the external apparatus;
a deletion step of, when the notification of receipt of the first content is received from the external apparatus at the reception step, deleting the first content from the recording medium; and
a second transmission step of, after the first content is deleted at the deletion step, transmitting second content out of the plurality of pieces of content to the external apparatus.

9. A recording medium storing a program for causing a communication apparatus to execute:
a specification step of specifying content to be transmitted to an external apparatus, out of pieces of content recorded in the recording medium;
a first transmission step of, when a plurality of pieces of content is specified at the specification step, transmitting first content out of the plurality of pieces of content to the external apparatus;
a reception step of, after the first content is transmitted at the transmission step, receiving a notification of receipt of the first content from the external apparatus;
a deletion step of, when the notification of receipt of the first content is received from the external apparatus at the reception step, deleting the first content from the recording medium; and
a second transmission step of, after the first content is deleted at the deletion step, transmitting second content out of the plurality of pieces of content to the external apparatus.

10. An information processing apparatus, comprising:
a content reception unit configured to receive specific content recorded in a recording medium of a first external apparatus;
a request transmission unit configured to, after the content reception unit receives the specific content, transmit a request for deleting the specific content to the first external apparatus;
a first notification reception unit configured to receive a notification of deletion of the specific content from the first external apparatus as a response to the request transmitted by the request transmission unit;
a content transmission unit configured to, after the notification reception unit receives the notification of deletion of the specific content, transmit the specific content to a second external apparatus;
a second notification reception unit configured to receive a notification that the reception of the specific content is completed from the second external apparatus; and
a deletion unit configured to, when the notification reception unit receives the notification, delete the specific content.

11. The information processing apparatus according to claim 10, wherein, when the specific content is a plurality of pieces of content including first content and second content, the content transmission unit receives the second content after the notification reception unit receives a notification of deletion of the first content.

12. The information processing apparatus according to claim 10, wherein, when the specific content is a plurality of pieces of content including first content and second content, the content transmission unit transmits the second content after the deletion unit deletes the first content.

13. The information processing apparatus according to claim 10, wherein, when the content transmission unit cannot transmit the specific content received by the content reception unit to the second external apparatus, the content transmission unit re-transmits the specific content.

14. The information processing apparatus according to claim 13, further comprising an input unit configured to accept a user operation to instruct for the re-transmission process.

15. The information processing apparatus according to claim 14, wherein the input unit is a physical button.

16. The information processing apparatus according to claim 15, wherein the physical button also functions as a power button in the information processing apparatus.

17. The information processing apparatus according to claim 10, wherein, even though the specific content received by the content reception unit is content with a protect attribute, the request transmission unit transmits a request for deleting the specific content to the first external apparatus.

18. The information processing apparatus according to claim 10, wherein the content is image data captured by an imaging unit.

19. A control method for an information processing apparatus, comprising:
a content reception step of receiving specific content recorded in a recording medium of a first external apparatus;
a request transmission step of, after the specific content is received, transmitting a request for deleting the specific content to the first external apparatus;
a first notification reception step of receiving a notification of deletion of the specific content from the first external apparatus as a response to the transmitted request;
a content transmission step of, after the notification of deletion of the specific content is received, transmitting the specific content to a second external apparatus;
a second notification reception step of receiving a notification that the reception of the specific content is completed from the second external apparatus; and
a deletion step of, when the notification that the reception of the specific content is completed is received, deleting the specific content.

20. A recording medium storing a program for causing an information processing apparatus to execute:
a content reception step of receiving specific content recorded in a recording medium of a first external apparatus;
a request transmission step of, after the specific content is received, transmitting a request for deleting the specific content to the first external apparatus;
a first notification reception step of receiving a notification of deletion of the specific content from the first external apparatus as a response to the transmitted request;
a content transmission step of, after the notification of deletion of the specific content is received, transmitting the specific content to a second external apparatus;
a second notification reception step of receiving a notification that the reception of the specific content is completed from the second external apparatus; and
a deletion step of, when the notification that the reception of the specific content is completed is received, deleting the specific content.
